(19) United States
(12) Patent Application Publication
(10) Pub. No.: US 2009/0217664 A1
(43) Pub. Date: Sep. 3, 2009

(54) Submerged Geo-Ocean Thermal Energy System

(75) Inventors: John W. Rapp, Manassas, VA (US); Robert James Howard, Clifton, VA (US); Nicholas J. Nagurny, Manassas, VA (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/396,349

(22) Filed: Mar. 2, 2009

Related U.S. Application Data
(60) Provisional application No. 61/033,415, filed on Mar. 3, 2008.
(60) Provisional application No. 61/042,185, filed on Apr. 3, 2008.

(51) Int. Cl. F03G 7/04

(52) U.S. Cl. 60/641.6; 60/641.2; 60/641.7

(57) ABSTRACT

A system for generating electrical energy using a naturally occurring temperature difference is disclosed. The system provides electrical energy by thermally conduit a geothermal heat source and cold deep-level water to opposing sides of a thermoelectric element. The thermoelectric element generates electrical energy based on the temperature difference between these two surfaces.

### CROSS REFERENCE TO RELATED APPLICATIONS

This case claims priority to: U.S. Provisional Patent Application Ser. No. 61/033,415, filed Mar. 3, 2008 (Attorney Docket: 711-136US); and U.S. Provisional Patent Application Ser. No. 61/042,185, filed Apr. 3, 2008 (Attorney Docket: 711-189US); each of which is incorporated herein by reference.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to energy systems in general, and, more particularly, to geothermal energy systems.

### BACKGROUND OF THE INVENTION

Non-petroleum-based energy sources are desirable. Geothermal and Ocean Thermal Energy Conversion (OTEC) systems represent two attractive such sources. Each can provide electrical energy through the exploitation of a naturally occurring temperature differential. In the case of geothermal systems, this temperature differential is between a naturally-occurring hot spot well below the earth's surface and the ambient temperature at the location of the geothermal system. For OTEC systems, this differential is between the temperature of ocean water at a deep level (e.g., >100 meters) and the temperature of water at the ocean's surface.

Geothermal systems have been in operation for many years. A conventional geothermal system typically uses a gas-driven turbine to turn an electrical generator. The electrical generator, in response, provides output electrical energy. The blades of the turbine are driven by either hot gas that come directly from the geothermal heat source or working fluid that is vaporized by the hot gas at a heat exchanger.

There are several problems with conventional geothermal systems that have thus far limited their use. First, the hot gas from the geothermal source is highly corrosive. As a result, the lifetime of the turbine and other system components can be compromised. Second, atmospheric temperature acts as the heat sink for conventional geothermal systems. The power generation capacity of a conventional geothermal system decreases as the ambient temperature at the turbine increases. This is due to the fact that the power generation is directly related to the temperature differential of the system. To further exacerbate matters, the reduction in power generation capacity tends to occur at times when such power is needed most (e.g., when it is hot out and air conditioning demand increases, etc.) Further, latitude and seasonal temperature variation cause variability in the power generation capability of these systems.

In a typical OTEC system, electrical energy is also generated by a generator that is driven by a turbine. The turbine is driven by means of a heat engine that forces vapor forced across its blades. The heat engine results from the temperature differential between deep ocean water and surface water. Conventional OTEC systems can either be open-cycle or closed-cycle. In an open-cycle system, warm seawater flows into a low-pressure container, wherein it boils and creates steam that drives the blades of the turbine. In closed-cycle system, warm surface seawater is pumped through a first heat exchanger where its heat vaporizes a working fluid. The vaporized working fluid then drives the turbine blades. Cold water is pumped from a deep water level through a second heat exchanger, where the working fluid is condensed to complete a closed cycle.

Like geothermal systems, OTEC systems also have several problems in practice. At most latitudes, seasonal temperature variations cause variations in their power generation capability. As a result, the deployment of OTEC systems is substantially limited to tropical regions. Further, the daily solar cycle induces variations in the temperature of the uppermost surface seawater. As a result, OTEC system deployment is practical primarily only in areas that have a thermocline with a deeper hot surface region so that the OTEC systems are not subject to diurnal fluctuations. Still further, localized weather conditions can temporarily obstruct sunlight or strengthen winds at the location of the OTEC system. Decreased solar energy and wind-driven evaporation will lower surface water temperature in the region.

### SUMMARY OF THE INVENTION

The present invention provides an energy generation system that avoids or mitigates some of the problems of prior-art energy generation systems. The present invention is an energy generation system that is based on a temperature differential between a geothermal heat source and a deep-water layer. Some embodiments of the present invention are particularly well-suited for deployment in deep-ocean environments that comprise a geothermal heat source, such as near a volcanic island.

In some embodiments, an energy generation system comprises an energy conversion unit that includes a first heat exchanger having a hot zone, a second heat exchanger having a cold zone, and a thermoelectric system for converting a temperature difference between the hot zone of the first heat exchanger and the cold zone of the second heat exchanger into electrical energy.

In some embodiments, the hot zone of the first heat exchanger and the geothermal heat source are thermally coupled through a closed-loop fluid system. In some embodiments, the hot zone of the first heat exchanger and the geothermal heat source are thermally coupled through a hydrothermal vent. An open-loop conduit conveys at least a portion of the hydrothermal vent through the first heat exchanger where it is thermally coupled with the hot zone. In some embodiments, the hot zone of the first heat exchanger and the geothermal heat source are thermally coupled through an earth crust penetrating rod. The penetrating rod is inserted into the geothermal heat source and conducts heat from the geothermal heat source to the first heat exchanger where the rod is thermally coupled with the hot zone.

The second heat exchanger comprises a cold zone whose temperature is regulated by the fact that it is thermally coupled to a deep-water layer. Preferably, the deep-water layer exhibits a high heat capacity and a temperature that is substantially constant regardless of latitude, weather conditions, the annual solar cycle, or even the daily solar cycle. The thermoelectric system interposes the first heat exchanger and the second heat exchanger.

In some embodiments, the hot zone of the first heat exchanger and cold zone of the second heat exchanger are interposed by a thermoelectric element having a first surface and a second surface. This thermoelectric element generates electrical energy as a function of temperature difference between the first and second surfaces. In some embodiments, this thermoelectric element comprises an element that generates electrical energy by means of the Peltier effect. In some embodiments, this thermoelectric element comprises a quantum-well thermoelectric element.

In still some other embodiments, the energy conversion unit is operatively coupled to a Rankine-cycle engine.

An embodiment of the present invention comprises: an energy conversion unit wherein the heat exchanger comprises a hot zone that is thermally coupled to a subterranean geothermal heat source, and a cold zone that is thermally coupled to a region of a body of water; a thermoelectric element that generates electrical energy based on a thermal differential between the hot zone and the cold zone; and a chamber for enclosing the heat exchanger and the thermoelectric element, wherein the chamber comprises a physical adaptation for withstanding external pressure that exceeds 1 atmosphere.

### BRIEF DESCRIPTION OF THE DRAWINGS

FIG. 1 depicts a schematic diagram of details of a prior-art dry steam geothermal energy conversion system.

FIG. 2 depicts a schematic diagram of details of a binary-cycle geothermal energy conversion system.

FIG. 3 depicts a schematic diagram of a portion of a representative OTEC power generation system in accordance with the prior art.

FIG. 4 depicts a schematic diagram of details of an energy conversion system in accordance with an illustrative embodiment of the present invention.

FIG. 5 depicts a method for generating electrical energy in accordance with the illustrative embodiment of the present invention.

FIG. 6 depicts calculated efficiencies of energy conversion cycles versus temperature differential for an energy conversion system in accordance with the present invention.

FIG. 7 depicts a schematic diagram of details of an energy conversion system in accordance with a first alternative embodiment of the present invention.

FIG. 8 depicts a schematic diagram of details of an energy conversion system in accordance with a second alternative embodiment of the present invention.

### DETAILED DESCRIPTION

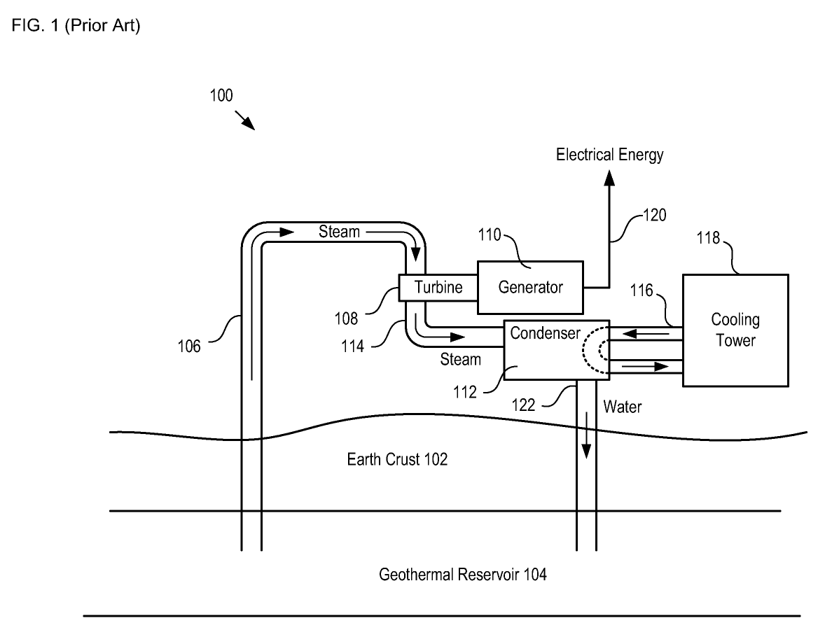

FIG. 1 depicts a schematic diagram of details of a prior-art dry steam geothermal energy conversion system. Energy system 100 comprises inlet conduit 106, turbine 108, generator 110, condenser 112, conduits 114 and 116, cooling tower 118, and outflow conduit 122. Turbine 108 and generator 110 collectively define a turbogenerator. In cases, a water pump is coupled to the outflow of condenser 112 to drive the return water to greater depths or to facilitate flow in a very long or narrow outflow conduit 122.

Inlet conduit 106 is inserted through earth crust 102 into geothermal reservoir 104. Inlet conduit 106 conveys steam from geothermal reservoir 104 to turbine 108. Turbine 108 is operatively coupled to generator 110.

The steam from geothermal reservoir 104 drive turbine 108, which turns generator 110 to produce electrical energy. The generated electrical energy is conveyed to an end user or storage facility on output cable 120.

Conduit 114 receives the steam that passes through turbine 108 and conveys it to condenser 112. At condenser 112, the steam is cooled by heat transfer fluid that circulates between cooling tower 118 and condenser 112 via conduit 116. The heat transfer fluid acts as a heat sink for the steam, inducing the steam to condense into water in condenser 112. Outlet conduit 122 conveys the condensate back to geothermal reservoir 104. Cooling tower 118 removes the absorbed heat in the heat transfer fluid by vaporizing water into the surrounding atmosphere prior to circulating the heat transfer fluid back to condenser 112.

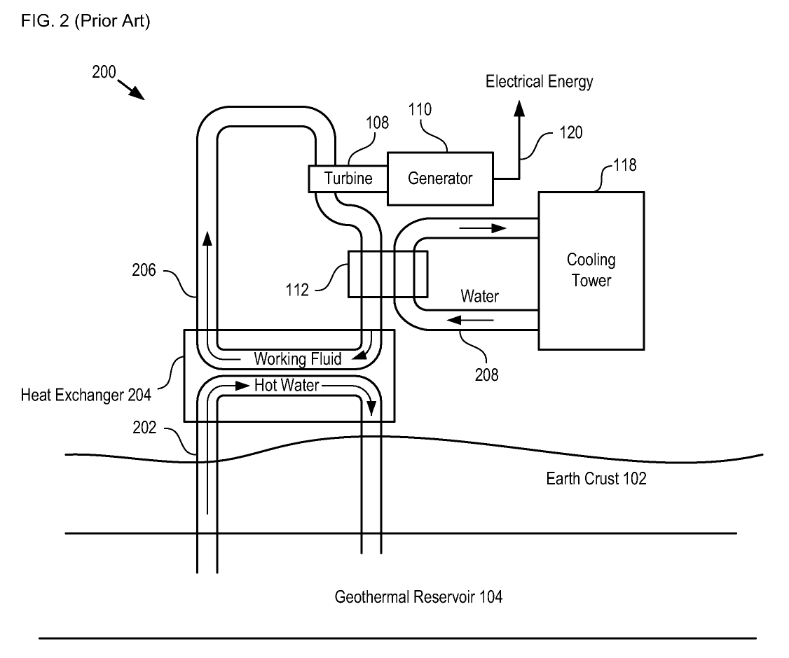

FIG. 2 depicts a schematic diagram of details of a binary-cycle geothermal energy conversion system. Energy system 200 comprises inlet conduit 202, heat exchanger 204, closed-loop conduit 206, turbine 108, generator 110, condenser 112, conduit 208, and cooling tower 118.

In operation, inlet conduit 202 conveys hot water and/or steam from geothermal reservoir 104 to heat exchanger 204. At heat exchanger 204, the heat of the hot water/steam in inlet conduit 202 heats a working fluid contained within closed-loop conduit 206. This working fluid evaporates into a pressurized vapor, which drives through turbine 108 to the condenser 112. The flow of pressurized vapor through turbine 108 causes the turbine to turn generator 110. In response, generator 110 generates electrical energy, which is conveyed to an end user on output cable 120.

After passing through the turbine, the depressurized vapor enters condenser 112. At condenser 112, the vapor is thermally coupled with cold water that flows through conduit 208, which induces the vapor to condense back into a liquid working fluid. Conduit 208 conveys cold water to and from cooling tower 118. Condensate pumps and filters are often included in the working fluid circuit to facilitate flow between condenser 112 and heat exchanger 204.

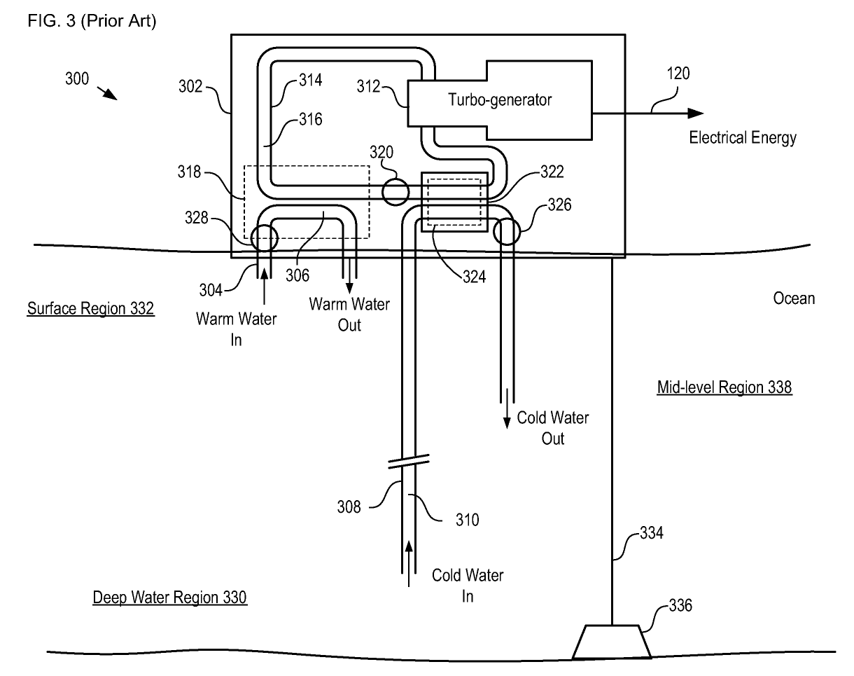

FIG. 3 depicts a schematic diagram of a portion of a representative OTEC power generation system in accordance with the prior art. OTEC system 300 comprises platform 302, surface water conduit 304, deep water conduit 308, turbogenerator 312, closed-loop conduit 314, heat exchanger 318, pump 320, and condenser 322.

Platform 302 is a conventional floating energy-plant platform. Platform 302 is anchored to the ocean floor by mooring line 334, which is connected to anchor 336. Anchor 336 is embedded in the ocean floor. In some instances, platform 302 is not anchored to the ocean floor and platform 302 is allowed to drift. Such a system is sometimes referred to as a “grazing plant.”

Surface water conduit 304 is a large-diameter conduit suitable for pumping water, by means of pump 328, from surface region 332 into heat exchanger 318.

Closed-loop conduit 314 is a closed-circuit loop of conduit that contains working fluid 316. Ammonia is commonly used as such a working fluid; however, there are many other fluids that can be used as working fluid 314.

Closed-loop conduit 314 and surface water conduit 304 are thermally coupled at heat exchanger 318. As a result, working fluid 316 and surface water 306 are also thermally coupled at heat exchanger 318. This enables the heat of surface water 306 to vaporize the working fluid 316. The expanding vapor turns turbogenerator 312, which generates electrical energy. The generated electrical energy is provided on output cable 120.

After passing through turbogenerator 312, the vaporized working fluid enters condenser 322, which comprises heat exchanger 324. At heat exchanger 324, closed-loop conduit 314 and deep water conduit 308 are thermally coupled, which enables the thermal coupling of the vaporized working fluid 316 and cold water 310. Cold water 310 is drawn from deep water region 330 by pump 326. Typically, deep water region 330 is 1000+ meters below the surface of the body of water. Water at this depth is at a substantially constant temperature of a few degrees centigrade. After passing through heat exchanger 324, cold water 310 is ejected into mid-level region 338 to avoid cooling the surface water near platform 302.

Cold water 310 acts as a heat sink for vaporized working fluid 316 at heat exchanger 324. As a result, the hot vaporized working fluid 316 is cooled by cold water 310 and condenses back into its liquid state. Once working fluid 316 is condensed, pump 320 recycles it back into heat exchanger 318 where it can be vaporized again to continue the cycle that drives turbogenerator 312.

Conventional OTEC systems have several drawbacks. First, it is difficult and energy intensive to pump cold water up from depths of 1000+ meters. This challenge is further exacerbated by the fact that cold water is more dense than warm water, which increases the energy required to draw it up to the surface. This significantly increases the cost and reduces the benefits of using an OTEC approach for power generation.

Second, for an OTEC generation system capable of generating 10's to 100's of megawatts, deep water conduit 308 typically has a diameter within the range of 3-10 meters and a length greater than 1000 meters. Such a conduit is difficult and expensive to manufacture.

Third, the size and length of deep water conduits makes them susceptible to damage from environmental conditions, such as strong currents, storms, and wave action. As a result, complicated and expensive infrastructure is required to protect these conduits from damage. For example, numerous recent efforts have been made to improve the reliability of cold water conduits. These include the development of flexible conduits, inflatable conduits, rigid conduits made from steel, plastics, and composites, and gimbal-mounted conduits. Even with such proposed innovations, long cold water conduits remain a significant reliability and cost issue.

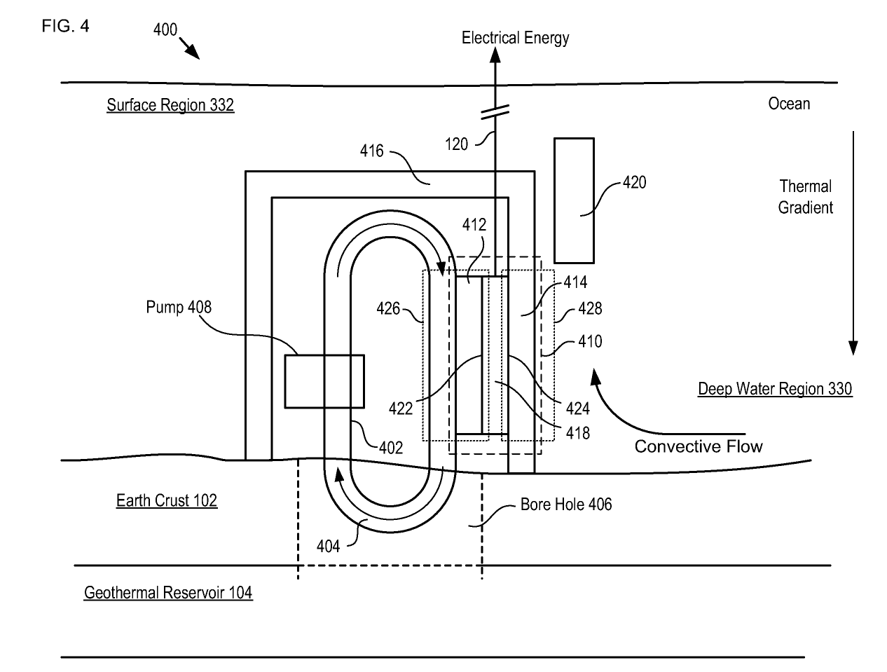

FIG. 4 depicts a schematic diagram of details of an energy conversion system in accordance with an illustrative embodiment of the present invention. Energy conversion system 400 comprises close-loop conduit 402, optional pump 408, energy conversion unit 410, pressure hull 416, and chimney 420. One skilled in the art will recognize, after reading this specification, that the present invention is suitable for operation in any suitable body of water, including, without limitation, oceans, seas, lakes, straights, gulfs, and bays.

Energy conversion unit 410 is a solid-state thermoelectric energy conversion system. Energy conversion unit 410 comprises hot zone 412, thermoelectric element 418, and cold zone 414, which is a portion of pressure hull 416.

Hot zone 412 comprises a substantially thermally conductive plate that enables the transfer of heat from close-loop conduit 402 to surface 422 of thermoelectric element 418.

Cold zone 414 is a portion of pressure hull 416 that is substantially thermally conductive. Cold zone 414 enables the thermal coupling of surface 424 of thermoelectric element 418 and cold water outside pressure hull 416.

Thermoelectric element 418 is a solid-state device that generates an open-circuit voltage based on a temperature difference between surfaces 422 and 424. In some embodiments, thermoelectric element 418 comprises a bismuth-telluride alloy. Commercial examples of thermoelectric element 418 include HZ modules available from Hi-Z Technology, Inc.

In some embodiments, thermoelectric element 418 is a solid-state element that generates electrical energy by means of the Peltier effect.

In some embodiments, energy conversion unit 410 comprises a classic Rankine-cycle engine instead of a solid-state thermoelectric element. In such embodiments, hot zone 412 and cold zone 414 are included in heat exchangers, such as heat exchangers 318 and 324 described above and with respect to FIG. 3. As a result, in these embodiments, hot zone 412 and cold zone 414 enable vaporization and condensation, respectively, of a working fluid as part of a Rankine cycle.

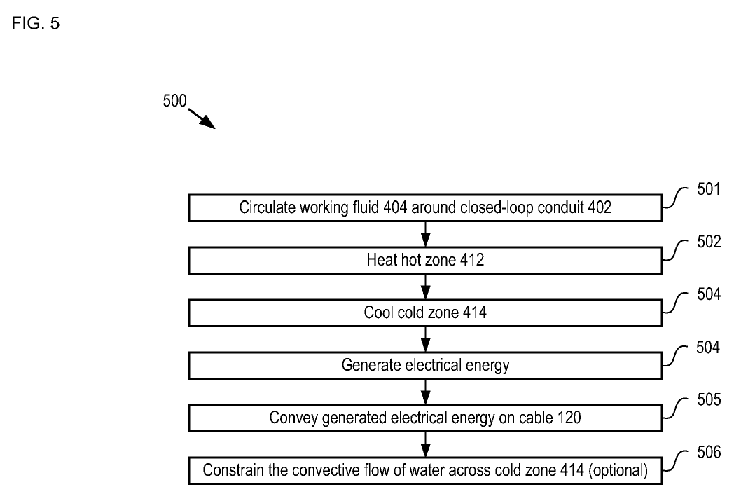

FIG. 5 depicts a method for generating electrical energy in accordance with the illustrative embodiment of the present invention. Method 500 is described herein with continuing reference to FIG. 4.

Method 500 begins with operation 501, wherein working fluid 404 is circulated through closed-loop conduit 402. Working fluid 404 is analogous to working fluid 316, described above and with respect to FIG. 3. In some embodiments, working fluid 404 is pumped through closed-loop conduit 402 by optional pump 408. Closed-loop conduit 402 passes through bore hole 406 into geothermal reservoir 104.

In some embodiments, pump 408 is not necessary since the temperature gradient between energy conversion unit 410 and geothermal reservoir 104 can inherently induce the flow of working fluid 404 through closed-loop conduit 402. As working fluid 404 loses its heat at energy conversion unit 410, it cools and naturally descends toward geothermal reservoir 104. This creates a natural convective flow (clockwise, as depicted in FIG. 4) around closed-loop conduit 402.

At operation 502, hot zone 412 is heated by virtue of thermally coupled working fluid 404. Hot zone 412 and a portion of closed-loop conduit 402 collectively define heat exchanger 426. Heat exchanger 426 thermally couples geo-thermal reservoir 104 and surface 422 of thermoelectric element 418.

At operation 503, cold zone 414 is cooled by cold water in deep water region 330. Cold zone 414 is cooled by virtue of heat exchanger 428, which comprises a portion of pressure hull 416 and is, therefore, in direct contact with the deep-level water. Heat exchanger 428 thermally couples surface 424 of thermoelectric element 418 with the deep-level water. Although in the illustrative embodiment cold zone 412 is a portion of pressure hull 416, it will be clear to one skilled in the art, after reading this specification, how to make and use alternative embodiments wherein cold zone 412 is a separate component from pressure hull 416. In some embodiments, one or more bore-hole fittings are used to couple closed-loop conduit 402 to a permanent conduit that resides within bore hole 406. In such embodiments, therefore, a substantial portion of energy conversion system 400 is detachable and removable.

Pressure hull 416 is a shell of structural material with sufficient strength to withstand the pressures that exist at deep water levels. The specific design of pressure hull 416 is based upon the intended application and deployment depth. For example, a pressure hull intended to be deployed at a depth of 1000 meters must be able to withstand water pressure that exceeds 100 atmospheres. In addition, pressure hull 416 comprises an electrical feed-through to enable generated electrical energy to be conveyed on cable 120.

In some embodiments, pressure hull 416 is a vessel that is filled with an incompressible, electrically non-conductive fluid. As a result, the need for the walls of pressure hull 416 to withstand externally applied high pressure is mitigated.

In some embodiments, energy conversion system 400 is suitable for deployment in environments wherein the water in surface region 332 has a substantially constant temperature of a few degrees centigrade, such as arctic regions. In such embodiments, the need for pressure hull 416 to withstand high external pressures is mitigated and pressure hull 416 can be replaced by a less robust, substantially water-tight chamber.

It is an aspect of the present invention that the water at a deep level of an ocean or similar body of water provides a heat sink with sufficient heat capacity to enable it to maintain a substantially constant temperature at all times. It is well-known that ocean temperatures drop with depth. For example, tropical and semi-tropical ocean temperatures at depths of 400, 500, and 1000 meters remain substantially constant at 12, 8, and 4° C., respectively. Deep water levels, therefore, have a heat-sink capability that is well-suited to the present invention.

At operation 504, thermoelectric element 418 generates electrical energy based on the temperature difference between hot zone 412 and cold zone 414.

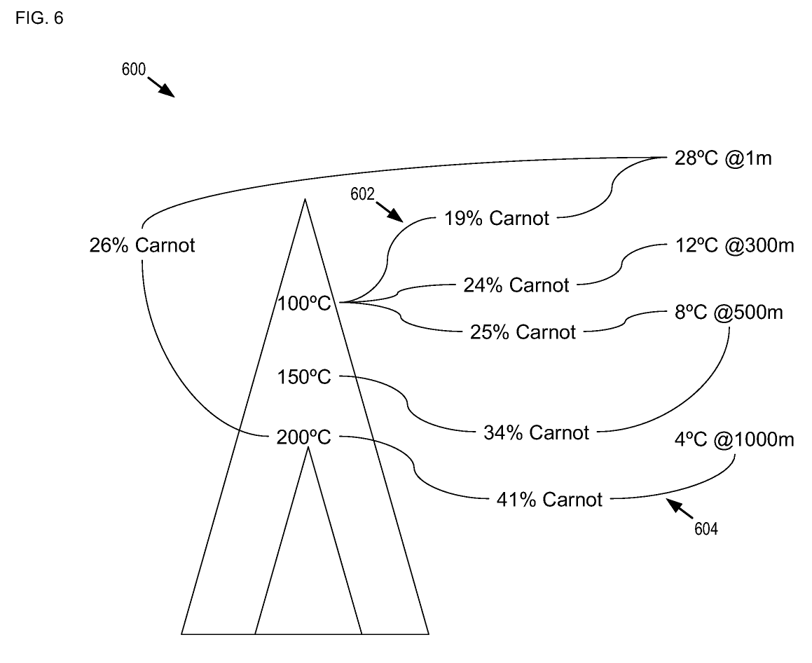

FIG. 6 depicts calculated efficiencies of energy conversion cycles versus temperature differential for an energy conversion system in accordance with the present invention. Plot 600 depicts the percentage of the Carnot cycle conversion efficiency for a range of temperature differentials that are based on water depths and geothermal heat source temperatures. As one skilled in the art will recognize, the Carnot cycle represents the most efficient cycle possible for converting a given amount of thermal energy into work.

Conversion cycle 602 depicts the efficiency for a thermoelectric energy conversion system based on the temperature differential between surface water (i.e., 1 m deep having a temperature of approximately 28° C.) and a relatively cool geothermal source (having a temperature of 100° C.). Although the systems in accordance with the present invention are operable for smaller temperature differentials, the temperature differential for conversion cycle 602 represents the smallest reasonable temperature cycle commonly available using a geothermal heat source. The energy conversion efficiency of conversion cycle 602 is a modest 19% of the Carnot cycle.

Conversion cycle 604, on the other hand, represents the largest temperature cycle commonly available using a geothermal heat source. Conversion cycle 604 is based on the temperature difference between water at 1000 m depth (having a temperature of approximately 4° C.) and a hot geothermal source (having a temperature of approximately 200° C.), the energy conversion efficiency is approximately 41% of the Carnot cycle. Conversion cycle 604, therefore, is characterized by a conversion efficiency that is 22% greater than that of conversion cycle 602. This represents an efficiency improvement of more than 100%.

At operation 505, the generated electrical energy is conveyed to the end-user via cable 120. In some embodiments, cable 120 terminates at a land-based installation. In some embodiments, cable 120 terminates at an open ocean vessel, such as an anchored barge, ship, spar platform, oil rig, dedicated power production platform, and the like. An open ocean vessel could be moored to nearby sea mounts, pinnacles, or the ocean floor.

At optional operation 506, the convective flow of cold water across cold zone 414 is constrained by chimney 420, thereby increasing the heat flow through the heat exchanger and seawater. The length of the chimney 420 is a matter of design choice, but is based on the temperature difference between the convecting seawater as it passes by cold zone 414 and the depth of the average thermocline at that temperature. The heat sink included in cold zone 414 would be designed to exhibit less head loss than the pressure difference (inside and outside) at the bottom of the chimney 420, minus the fluid drag up the chimney 420. In some embodiments, chimney 420 is not used since the rate at which the convective flow of cold water flows across cold zone 414 is sufficient to ensure that the ambient temperature of the water in the local area of cold zone 414 does not substantially increase during operation of energy system 400.

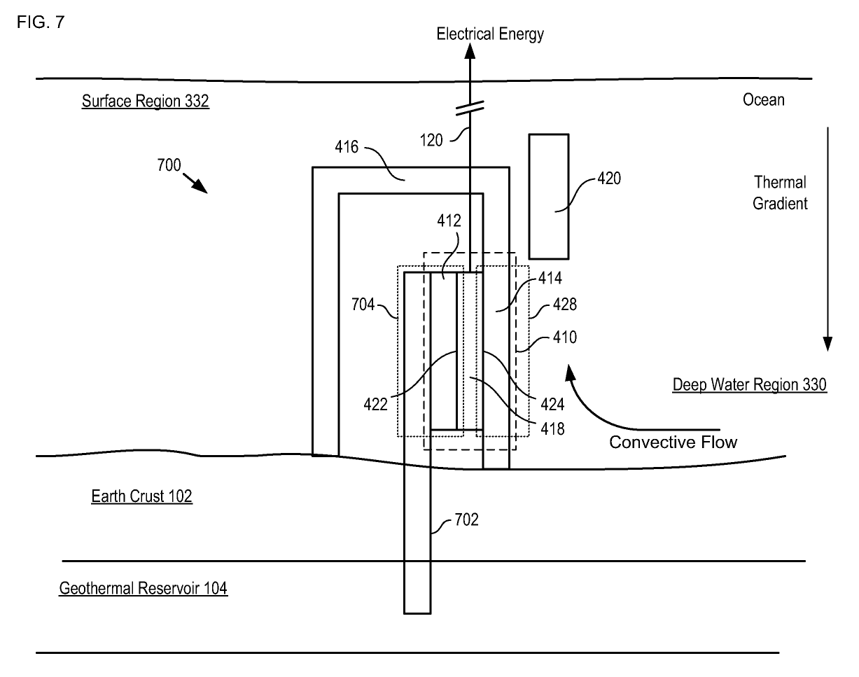

FIG. 7 depicts a schematic diagram of details of an energy conversion system in accordance with a first alternative embodiment of the present invention. Energy conversion system 700 comprises close-loop conduit 402, optional pump 408, energy conversion unit 410, pressure hull 416, chimney 420, and rod 702.

Rod 702 is a crust-penetrating rod suitable for insertion into the hot material of geothermal reservoir 104. Rod 702 comprises structural material that is substantially thermally conductive. As a result, rod 702 conducts heat from geothermal reservoir 104 into heat exchanger 704, which comprises rod 702 and hot zone 412.

At heat exchanger 704, heat from geothermal reservoir 104 is absorbed by hot zone 412. Operation of system 700 is analogous to the operation of system 400, described above and with respect to FIGS. 4 and 5.

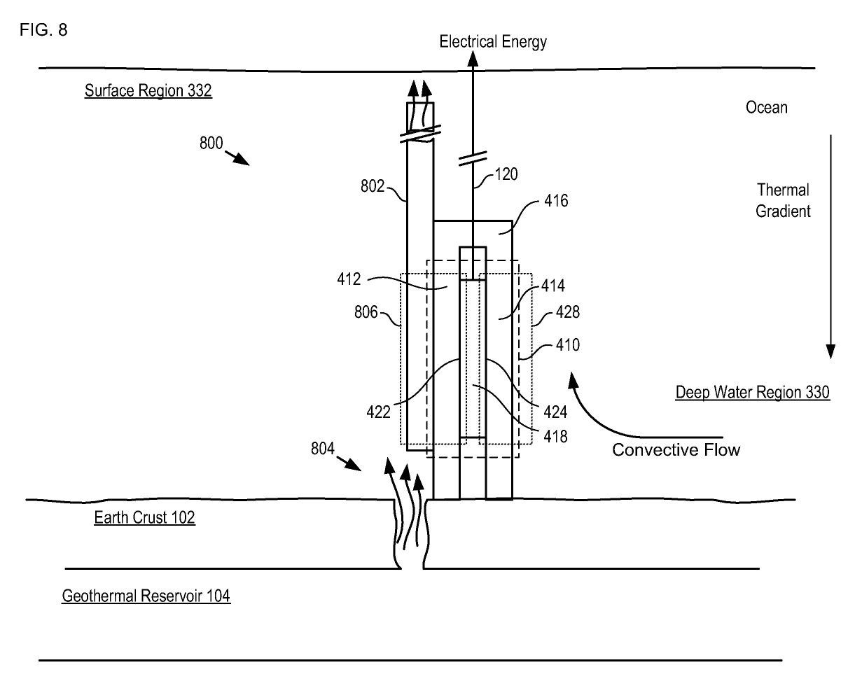

FIG. 8 depicts a schematic diagram of details of an energy conversion system in accordance with a second alternative embodiment of the present invention. Energy conversion system 800 comprises close-loop conduit 402, optional pump 408, energy conversion unit 410, pressure hull 416, chimney 420, and conduit 802.

Conduit 802 receives water of hydrothermal vent 804. This water has been heated by the hot material of geothermal reservoir 104. As a result, conduit 802 conducts heat from geothermal reservoir 104 into heat exchanger 806, which comprises a portion of conduit 802 and hot zone 412.

At heat exchanger 806, therefore, heat from water of hydrothermal vent 804 is absorbed by hot zone 412. After the water of ocean thermal vent 804 exits heat exchanger 806, conduit 802 exhausts it to a region of the body of water that is sufficiently displaced from cold zone 404 to avoid heating the water outside of pressure hull 416.

Operation of system 800 is analogous to the operation of system 400, described above and with respect to FIGS. 4 and 5.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An apparatus for generating electrical energy comprising:
an energy conversion unit, wherein the energy conversion unit comprises;
a hot zone that is thermally coupled to a subterranean geothermal heat source; and
a cold zone comprising a first physical adaptation for thermally coupling with a region of a body of water;
a thermoelectric element, wherein the thermoelectric element generates electrical energy based on a thermal differential between the hot zone and the cold zone; and
a chamber, wherein the chamber encloses the energy conversion unit and the thermoelectric element, and wherein the chamber comprises a second physical adaptation for withstanding external pressure that exceeds 1 atmosphere.

2. The apparatus of claim 1 further comprising a closed-loop fluid system for thermally conduit the hot zone to the geothermal heat source.

3. The apparatus of claim 2 further comprising a pump for inducing circulation of a fluid through the closed-loop fluid system.

4. The apparatus of claim 1 wherein the body of water is an ocean.

5. The apparatus of claim 1 further comprising a conduit, wherein the conduit enables the thermally coupling of the hot zone and a hydrothermal vent from the geothermal heat source.

6. The apparatus of claim 1 further comprising a rod, wherein the rod is thermally coupled with the geothermal heat source, and wherein the rod thermally couples the geothermal heat source and the hot zone.

7. The apparatus of claim 1 wherein the region of the body of water has a temperature that is substantially constant, and further wherein the temperature differential between the region and the geothermal heat source is at least 70° C.

8. The apparatus of claim 7 further comprising a conduit for conveying water heated by the energy conversion unit away from the cold zone.

9. The apparatus of claim 1 wherein the thermoelectric element comprises a Rankine-cycle engine.

10. The apparatus of claim 1 wherein the thermoelectric element comprises a solid-state thermoelectric element.

11. The apparatus of claim 10 wherein the thermoelectric element generates electrical energy by means of the Peltier effect.

12. The apparatus of claim 10 wherein the thermoelectric element comprises a quantum-well thermoelectric element.

13. The apparatus of claim 1 wherein the physical adaptation comprises a pressure hull.

14. A method for generating electrical energy comprising:
thermally coupling a hot zone of an energy conversion unit to a subterranean geothermal heat source;
thermally coupling a cold zone of the energy conversion unit to a region of a body of water; and
generating electrical energy based on the temperature differential between the hot zone and the cold zone.

15. The method of claim 14 further comprising enabling the flow of a fluid through a closed-loop conduit, wherein the fluid and the geothermal heat source are thermally coupled, and wherein the fluid and the hot zone are thermally coupled, and wherein the fluid thermally couples the hot zone and the subterranean geothermal heat source.

16. The method of claim 14 wherein the cold zone and the region of the body of water are thermally coupled by exposing the cold zone to direct contact with water of the region.

17. The method of claim 16 further comprising:
sinking heat from the cold zone into a first volume of the water; and
constraining the flow of the first volume through the region to a conduit, wherein the conduit enhances the motion of the first volume away from the cold zone.

18. The method of claim 14 further comprising enabling the flow of a fluid from the subterranean geothermal heat source to the hot zone.

19. The method of claim 18 further comprising pumping the fluid from the subterranean geothermal heat source to the hot zone.
